(19) United States
(12) Patent Application Publication
(10) Pub. No.: US 2025/0266497 A1
(43) Pub. Date: Aug. 21, 2025

(54) Lithium Phosphorus Sulfide Halide-Polymer Composite and Methods of Making Thereof

(71) Applicant: The Regents of the University of California, Oakland, CA (US)

(72) Inventors: Gao Liu, Piedmont, CA (US); Piyachai Khomein, Berkeley, CA (US)

(21) Appl. No.: 19/058,543

(22) Filed: Feb. 20, 2025

Related U.S. Application Data
(60) Provisional application No. 63/555,987, filed on Feb. 21, 2024.

(51) Int. Cl. H01M 10/0562; H01M 10/052

(52) U.S. Cl. CPC H01M 10/0562; H01M 10/052; H01M 2300/008; H01M 2300/0091

(57) ABSTRACT

This disclosure provides systems, methods, and apparatus related to lithium phosphorus sulfide halide-polymer composites. In one aspect, a lithium phosphorus sulfur halide (LiPSX) solution and a polymer solution are provided. X is chlorine, bromine, iodine, or combinations thereof. LiPSX of the LiPSX solution and a polymer of the polymer solution are precipitated by mixing the LiPSX solution and the polymer solution. A LiPSX solvent of the LiPSX solution and a polymer solvent of the polymer solution are removed from the LiPSX and the polymer to form polymer-embedded LiPSX.

### RELATED APPLICATIONS

This application claims priority to U.S. Provisional Patent Application No. 63/555,987, filed 21 Feb. 2024, which is herein incorporated by reference.

### STATEMENT OF GOVERNMENT SUPPORT

This invention was made with government support under Contract No. DE-AC02-05CH11231 awarded by the U.S. Department of Energy. The government has certain rights in this invention.

### BACKGROUND

All-solid-state batteries (SSBs) have been considered the next-generation energy storage system due to many advantages over organic liquid electrolyte-based batteries. For example, they inherit low fire hazards due to lacking flammable organic components. They are also promising for lower-cost manufacturing per power output ($/kWh) compared to current liquid electrolyte-based Li-ion batteries. In addition, energy density can further be improved using a Li-metal anode, which has not been successful in liquid electrolyte systems due to insuppressible Li dendrite formation. Utilizing a solid electrolyte with a Li-metal anode has been regarded as a promising way to reduce Li dendrite growth due to their high mechanical strength and high Li⁺ transference number.

Over the past several years, there have been efforts focused on developing solid electrolytes with high ionic conductivity, and the research field has experienced tremendous growth. The combination of theory and experimental work has led to the discovery of new materials such as lithium phosphorus oxynitride (Li₃PO₄, LiPON), Lithium Super-Ionic CONductor families (LISICONs), lithium lanthanum zirconium oxide (Li₇La₃Zr₂O₁₂, LLZO), and lithium phosphorus sulfide (LiₓP_{y}S_{z}, LPS) families. However, recent reports have indicated that lithium dendrites can still form in these solid electrolytes and are, in fact, more easily formed in LLZO and LPS than in the liquid electrolyte. The dendrite tends to form along grain boundaries and voids in a solid electrolyte, and increasing the density of the solid electrolyte to minimize the grain boundaries has not successfully prevented such a dendrite formation. Even in the single-crystalline LLZO system, the dendrite growth was still observed. Recently, one research group found the direct nucleation and dendrite formation inside LLZO and LPS, suggesting that the electronic conduction across solid electrolyte materials could cause the dendrite growth inside these solid electrolytes. Therefore, lowering the overall electronic conductivity of the solid electrolyte while maintaining its high ionic conductivity is a challenge for the success of all-solid-state Li-metal batteries.

In this regard, a composite solid electrolyte including a polymer can be a promising approach, as it has been shown to improve not only its stability toward dendrite formation but also enhance its electrochemical performance including high-voltage stability, improve ion transference number, minimize interface reaction, and have better mechanical properties for ease of processability and a thinner separator layer. Typically, the composites can be prepared by mechanical mixing or dispersion of a solid electrolyte in the polymer solution, followed by solvent removal.

For instance, a ball-milling technique was employed to prepare an LPS polymer composite (25 wt % polymers). An electrolyte, with a thickness of <70 μm, was successfully fabricated with ionic conductivity ranging between 0.05 and 0.1 mS/cm. However, the nonuniform distribution of polymer in a solid electrolyte composite is a concern when using a mechanical mixing method, which can impact the Li-ion transport and overall mechanical properties of composites.

Solution dispersion can provide better uniform distribution between the polymer and the solid electrolyte. A 5 wt % polyethylene oxide in lithium phosphorus sulfide chloride (PEO/LiPSCl) composite has been reported to improve the full cell cycling performance using LiNi_{0.8}Co_{0.1}Mn_{0.1}O₂ and Li metal as electrodes with a 91% capacity retention over 200 cycles. Another composite of poly(vinylidene fluoride) (PVDF) and LiPSCl (i.e., Li₆PS₅Cl) also has been reported with a conductivity of 1 mS/cm for a 10 wt % PVDF composite and the thickness of 100 μm to 120 μm was successfully fabricated.

### SUMMARY

For the existing preparation methods for composite solid electrolyte, either mechanical mixing or dispersion, it was found that the uniformity of the polymer distribution is impeded when applying a higher polymer load (greater than about 8 wt %). Phase separation could weaken the composite's mechanical strength, which is an important factor in pressure-driven dendrite blocking.

Described herein is another approach for a new class of sulfide-polymer composite synthesis via low-temperature solution-precipitation processes. FIG. 1A shows a diagram comparing three methods for preparing a solid electrolyte (SE)-polymer composites. In some embodiments, the methods described further herein use soluble LiPSCl in a polar solvent to provide single-phase mixing for a uniformly distributed polymer composite solid electrolyte to suppress the dendrite formation. Further, the evenly distributed polymer can also prevent the formation of an electronic conducting interphase between solid electrolyte and electrodes. The synthesis of LiPSCl-polymer composite (PEO and PPO) via a solution-precipitation method, which can improve the conductivity up to about 0.3 mS/cm (about 12 wt % of polymer), is further described herein.

One innovative aspect of the subject matter described in this disclosure can be implemented in a method including providing a lithium phosphorus sulfur halide (LiPSX) solution and a polymer solution. X is chlorine, bromine, iodine, or combinations thereof. LiPSX of the LiPSX solution and a polymer of the polymer solution are precipitated by mixing the LiPSX solution and the polymer solution. A LiPSX solvent of the LiPSX solution and a polymer solvent of the polymer solution are removed from the LiPSX and the polymer to form polymer-embedded LiPSX.

Another innovative aspect of the subject matter described in this disclosure can be implemented in a method including providing a lithium phosphorus sulfur chloride (LiPSCl) solution and a solution of polyethylene oxide. LiPSCl and polyethylene oxide are precipitated by mixing the LiPSCl solution and the solution of polyethylene oxide. Ethanol of the LiPSCl solution and acetonitrile of the solution of polyethylene oxide are removed from the LiPSCl and the polyethylene oxide to form polyethylene oxide-embedded LiPSCl.

Another innovative aspect of the subject matter described in this disclosure can be implemented in a method including providing a lithium phosphorus sulfur chloride (LiPSCl) solution and a solution of poly(phenylene oxide). LiPSCl and poly(phenylene oxide) are precipitated by mixing the LiPSCl solution and the solution of poly(phenylene oxide). Ethanol of the LiPSCl solution and a polymer solvent of the solution of poly(phenylene oxide) are removed from the LiPSCl and the poly(phenylene oxide) to form poly(phenylene oxide)-embedded LiPSCl. The polymer solvent is a solvent from a group toluene, benzene, xylene, dioxolane, and glyme.

Another innovative aspect of the subject matter described in this disclosure can be implemented in material including particles of a lithium phosphorus sulfur halide (LiPSX), with X being one or more halides, disposed in a polymer matrix. The LiPSX has an argyrodite-type crystal structure. In some implementations, the lithium phosphorus sulfur halide is Li₆PS₅X. In some implementations, X is a halide from a group chlorine, bromine, iodine, and combinations thereof. In some implementations, the polymer is a polymer from a group triethylene glycol dimethacrylate, triethylene glycol acrylate, diethylene glycol dimethacrylate, diethylene glycol diacrylate, ethylene glycol dimethacrylate, and ethylene glycol diacrylate.

Details of one or more embodiments of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A shows a diagram comparing three methods for preparing a solid electrolyte (SE)-polymer composites. Note that the solution-precipitation method has the advantage of high mechanical strength owing to its smaller polymer domain size and uniformly distributed microstructure.

FIG. 1B shows an example of a flow diagram illustrating a synthesis process for an electrolyte-polymer composite.

FIG. 1C shows a schematic diagram illustrating a solution-precipitation method by co-precipitation of LiPSCl and polymer solutions to yield a polymer-embedded LiPSCl cluster.

FIGS. 2A-2E show the morphological and structural changes with dissolution time of LiPSCl in EtOH. SEM images of (FIG. 2A) pristine LiPSCl powder and (FIG. 2B) LiPSCl precipitate after dissolution in EtOH for 5 minutes and (FIG. 2C) after dissolution for 30 minutes. Scale bars in the SEM images are 10 μm. FIG. 2D shows XRD results of LiPSCl with a different dissolution time in EtOH. As time increases, the intensities of the representative LiPSCl peaks (denoted as a triangle) decreases. Note that the sharp peak at ˜13° and the bump peak at ˜20° are from an airtight XRD holder. FIG. 2E shows ionic conductivities of LiPSCl with different dissolution times. Note that a shorter dissolution time of LiPSCl is preferred, as a shorter dissolution times yield a higher conductivity.

FIGS. 3A and 3B show comparisons of (FIG. 3A) reduced Young's moduli and (FIG. 3B) hardnesses obtained from nanoindentation tests. The effect of the polymer content was also investigated. Mechanical properties of 2 wt %, 8 wt %, and 12 wt % PEO and LiPSCl composites are compared as well as those of the pristine LiPSCl and the precipitated LiPSCl.

FIGS. 4A and 4B show comparisons of (FIG. 4A) reduced Young's modulus and (FIG. 4B) hardness of the LiPSCl-PPO composites. The composite samples were annealed at 400° C. before the mechanical tests.

FIGS. 5A-5D show lithium striping/plating cycle properties of (FIG. 5A) pristine LiPSCl and LiPSCl-PPO composite prepared by (FIG. 5B) mechanical mixing, (FIG. 5C) dispersion mix, and (FIG. 5D) solution-precipitation methods.

### DETAILED DESCRIPTION

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise.

The terms “about” or “approximate” and the like are synonymous and are used to indicate that the value modified by the term has an understood range associated with it, where the range can be ±20%, ±15%, ±10%, ±5%, or ±1%. The terms “substantially” and the like are used to indicate that a value is close to a targeted value, where close can mean, for example, the value is within 80% of the targeted value, within 85% of the targeted value, within 90% of the targeted value, within 95% of the targeted value, or within 99% of the targeted value.

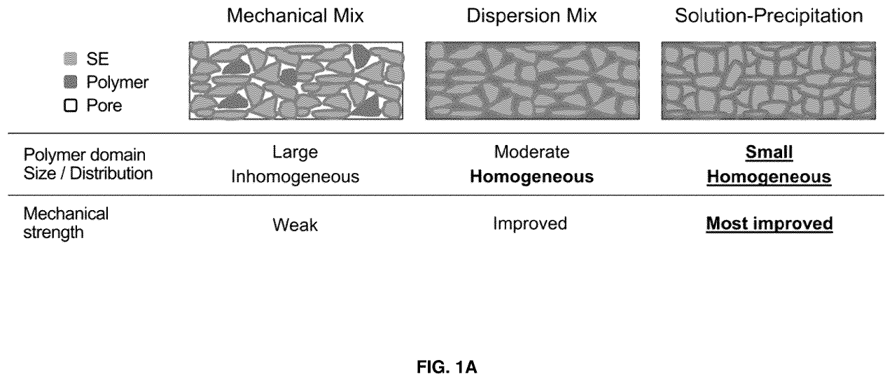

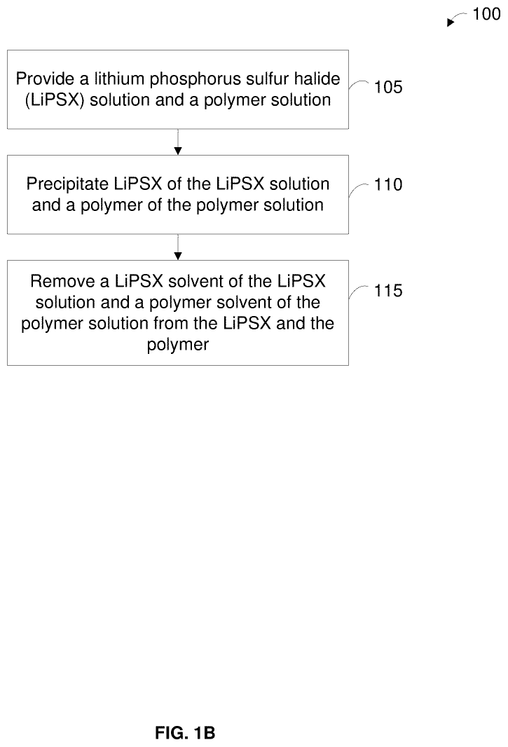

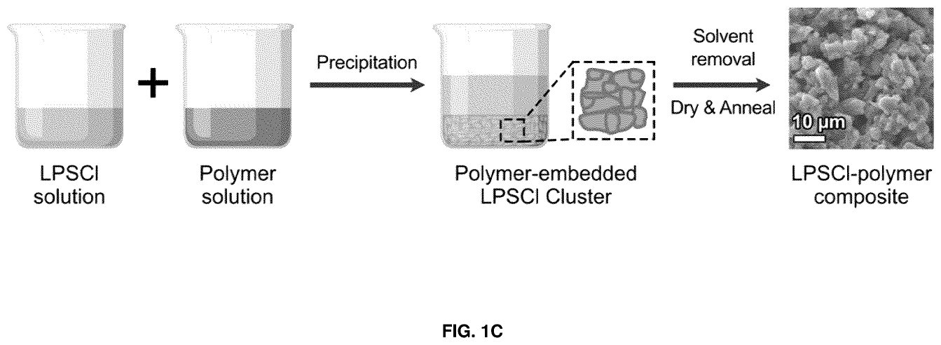

FIG. 1B shows an example of a flow diagram illustrating a synthesis process for an electrolyte-polymer composite. Such an electrolyte-polymer composite can be used as a solid electrolyte in a battery. Starting at block 105 of the process 100, a lithium phosphorus sulfur halide (LiPSX) solution and a polymer solution are provided. X is chlorine, bromine, iodine, and combinations thereof.

In some embodiments, the LiPSX is LiPSCl. In some embodiments, a LiPSX solvent of the LiPSX solution comprises a polar solvent. In some embodiments, a LiPSX solvent of the LiPSX solution is or comprises ethanol.

In some embodiments, the polymer comprises polyethylene oxide and the polymer solvent comprise acetonitrile. In some embodiments, the polymer comprises poly(phenylene oxide) and the polymer solvent is a solvent from a group toluene, benzene, xylene, dioxolane, and glyme.

At block 110, the LiPSX of the LiPSX solution and a polymer of the polymer solution are precipitated by mixing the LiPSX solution and the polymer solution.

At block 115, a LiPSX solvent of the LiPSX solution and a polymer solvent of the polymer solution are removed from the LiPSX and the polymer to form polymer-embedded LiPSX. In some embodiments the LiPSX solvent and the polymer solvent are removed by evaporation. In some embodiments, the polymer-embedded LiPSX is in the form of clusters.

In some embodiments, the process 100 further includes annealing the polymer-embedded LiPSX at about 400° C. or greater to further crystallize the LiPSX.

In some embodiments, the process 100 further includes grinding the polymer-embedded LiPSCl to form a powder. In some embodiments, the powder of the polymer-embedded LiPSX has particle sizes reduced to about 0.1 microns to 50 microns.

In some embodiments, the process 100 further includes compressing the powder to form an electrolyte. In some embodiments, the electrolyte is about 2 weight % polymer or greater, about 8 weight % polymer or greater, or about 12 weight % polymer or greater.

FIG. 1C shows a diagram illustrating the preparation process of the solution-precipitation method by co-precipitation of LiPSCl and polymer solutions to yield a polymer-embedded LiPSCl cluster.

The following examples are intended to be examples of the embodiments disclosed herein, and are not intended to be limiting.

### Example—Polymer Composites Via the Solution-Precipitation Method

A solution of LiPSCl and polymer was prepared as follows. LiPSCl was dissolved in ethanol at a concentration of 0.2 g/mL. PEO was dissolved in acetonitrile and PPO was dissolved in toluene at a concentration of 1 mg/mL, 5 mg/mL, and 10 mg/mL for both polymers. Then, the LiPSCl solution and polymer solution were co-precipitated in centrifuge tubes. The mixture was centrifuged at 6000 rpm for 10 minutes. The overall processing time of LiPSCl, including dissolution, precipitation, and separation steps, was controlled to be less than 15 minutes to minimize the negative effect of EtOH on LiPSCl. The solvent was then discarded, and the precipitate was dried under a vacuum at room temperature overnight. For the PPO-LiPSCl composite, the sample was further dried at 60° C. for at least 2 hours. Finally, the composites were ground to yield a gray powder composite. According to elemental analysis results, the polymer content in the composites is confirmed as 2 wt %, 8 wt %, and 12 wt % from the solution-precipitation method using polymer solutions (i.e., PEO in acetonitrile and PPO in toluene) of 1 mg/mL, 5 mg/mL, and 10 mg/mL, respectively.

### Example—Pellet Preparation

Pellets were pressed in a stainless steel pellet pressing die-set 6 mm in diameter. Briefly, each pellet was pressed using 50 mg of powder composite and 350 MPa was applied and held for at least 30 seconds, providing a pellet with a thickness of 1.2 mm. For the PEO composite, the pellets were annealed at 180° C. in a vacuum oven, while PPO composite pellets were annealed at 400° C. under an argon atmosphere overnight.

Example—Experimental Results—Effects of ethanol on LiPSCl

The solution-precipitation approach described above was used to prepare LiPSCl-polymer composites using polyethylene oxide (PEO) and poly(phenylene oxide) (PPO) polymers. PEO can provide conductive ion channels via ethylene oxide and Li-ion complex. In contrast, PPO is one of the thermally stable polymers due to its sp² character, which can offer a post-thermal treatment at high temperatures.

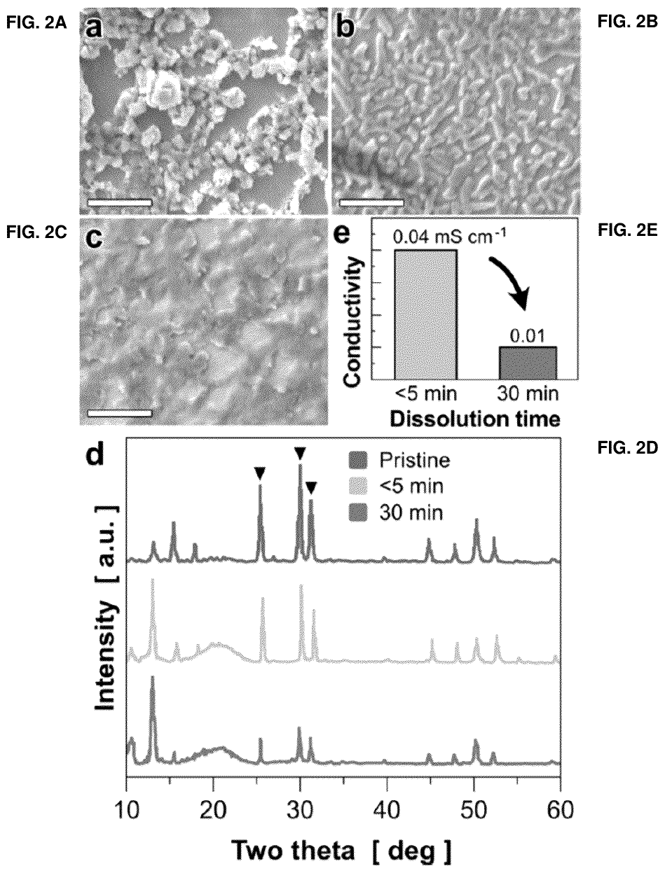

According to the literature, ethanol (EtOH) can be used as a solvent to infiltrate LiPSCl into a porous cathode composite. Still, the overall liquid process must be performed in less than 1 hour due to the time-sensitive property of the LiPSCl in the solvent. Thus, the effect of dissolution time on the LiPSCl properties was investigated, as shown in FIGS. 2A-2E. SEM images (FIGS. 2A-2C) show the decrease in the grain size of the solid electrolyte with the dissolution time in EtOH, and the well-defined particle shape was lost at a longer dissolution times (30 minutes). In addition, XRD results show a decrease in the signal for both cases compared to the pristine LiPSCl, but the 30 minute sample shows the lowest intensity of XRD peaks among the samples (FIG. 2D). Note that the sharp peak at ˜13° and the bump peak at ˜20° come from an airtight XRD holder used to generate the patterns shown in FIG. 2D. A decrease in the ionic conductivity with the dissolution time is also observed (FIG. 2E). The 30 minute sample shows a comparatively lower conductivity (0.01 mS/cm) than the 5 minute sample (0.04 mS/cm).

These results suggest that the dissolution of LiPSCl in EtOH will affect the overall crystal structure and ionic conductivity of the recovered precipitates and those properties are strongly dependent on the dissolution time. Thus, the solution-precipitation method requires the minimum exposure of LiPSCl to EtOH to minimize the depletion of the crystal structure of LiPSCl and may require additional heat treatment to recover some crystal structure and ionic conductivity of LiPSCl.

### Example—Morphological and Mechanical Properties of the LiPSCl-Polymer Composites

To evaluate the proposed solution-precipitation method, the morphological and mechanical properties of the LiPSCl-polymer composites with other preparation methods was investigated. First, the morphology of LiPSCl-PEO composites using SEM images was investigated. Regardless of the polymer content, all composites displayed similar morphology with crystal grain sizes between 1 μm and 10 μm. Unlike the size of LiPSCl, which decreased after the precipitation without polymer (FIGS. 2A-2E), the feature size of the polymer composite appears to be preserved when the precipitation was performed in the polymer solution. This result suggests that the polymer promotes LiPSCl precipitation and possibly limits ethanol accessibility to LiPSCl.

Because the polymer phase in SEM images could not be identified, TEM-EDS analyses were performed to track how the polymer distributes on the composites. For the TEM analyses, an airtight sample transfer TEM holder was used to avoid any potential degradation of the composite due to air exposure. Considering that all sample preparation procedures were conducted without air exposure, oxygen (O) elemental distribution in the EDS maps is expected to represent the presence of PEO along with the LiPSCl phase. To compare the elemental distribution clearly, bi-elemental maps of P—O and P—Cl were placed next to each STEM-HAADF image. For the 2 wt % polymer composites prepared by the dispersion mix method, a nonuniform distribution of PEO is observed (i.e., in bi-elemental maps of P—O). For example, one can observe the phase separation of PEO-rich and LiPSCl-rich domains. In contrast, the solution-precipitation method created a uniform distribution of PEO in LiPSCl composites, with no obvious phase separation between PEO-rich and LiPSCl-rich domains being identified. These results confirm that the solution-precipitation method is better than the dispersion mix method for a uniform distribution of the polymer phase at a submicron-scale level.

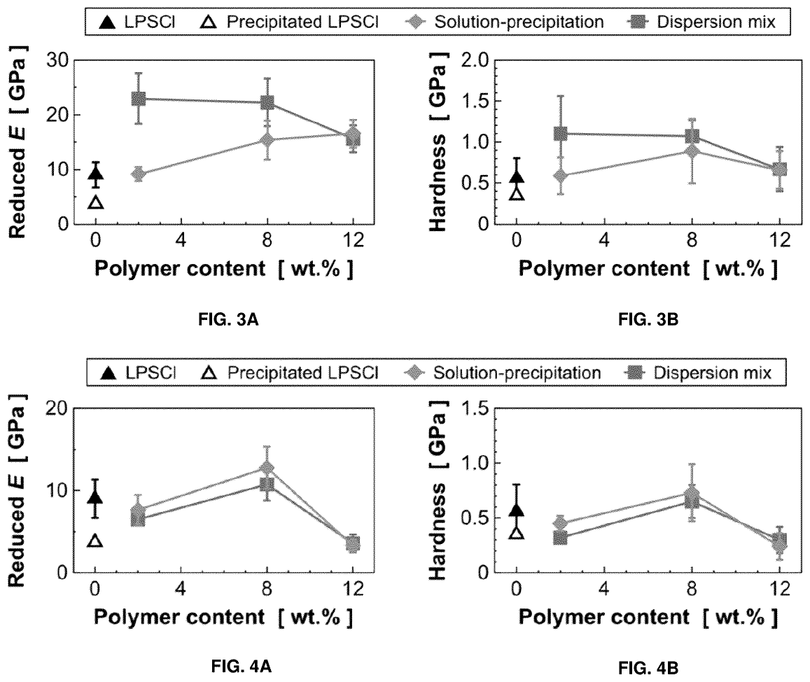

The mechanical properties of the LiPSCl-PEO composites were evaluated via nanoindentation tests (FIGS. 3A and 3B). As expected, the reduced Young's modulus of the dispersion composites decreases as the polymer content increases (FIG. 3A). This result is likely attributable to the phase separation between PEO and LiPSCl, causing poor interactions between the two phases. In contrast, the reduced Young's modulus of the composites prepared via the solution-precipitation method increases as the polymer content increases, confirming the importance of polymer distribution in solid electrolyte composite for better mechanical reinforcement. For the hardness, the trend of both types of samples is similar, and the values decrease when the polymer content increases (FIG. 3B). This is an understandable result because PEO is a soft material: increasing PEO content will correspondingly lower the hardness of the composite materials. The hardness of the 8 wt % solution-precipitation composites seems to increase, but the value is insignificant given the relatively large error scale.

Composites generated by the solution-precipitation method exhibited lower mechanical properties than those prepared via dispersion mix. This difference is more clearly observed with a lower polymer content. One explanation is that the difference originates from the structural degradation of LiPSCl during the solution-precipitation process, as previously shown in FIGS. 2A-2E. The dispersion method was performed using the pristine LiPSCl, which has improved crystallinity and mechanical properties. In contrast, the degradation of the solution-precipitation method was present even in the shortest process time (<15 minutes). A general process to recover the crystallinity of LiPSCl is annealing at a high temperature, typically above 400° C. To find a proper temperature to anneal the composite without decomposing the polymers, the thermal decomposition of PEO was tested using TGA. The decomposition temperature onset for PEO was about 350° C. Because there was no significant improvement in the crystallinity as well as the conductivity of the LiPSCl-PEO composite if it was annealed at lower than 350° C., the LiPSCl-PEO composite was annealed at 180° C. It might be difficult to achieve a high crystallinity of LiPSCl in typical ways in the composite with PEO.

Accordingly, the properties of the LiPSCl-PPO composites prepared by the solution-precipitation method were investigated. Owing to the higher thermal stability of polyphenylene oxide (PPO) than that of the PEO, a higher crystallinity of LiPSCl by allowing a higher temperature (400° C.) for the annealing process was expected to be achieved. The observed morphology of the LiPSCl-PPO composite via SEM analysis is quite similar to that of the LiPSCl-PEO composites; their crystal grain size ranges from 1 μm to 10 μm, and the polymer phase is not distinguishable in SEM images. Thus, elemental mapping was performed using TEM-EDS to monitor the polymer distribution in the composites. There was a good distribution of the O element, which represents the polymer phase, and the P element, which represents the LiPSCl phase, regardless of the PPO content. There are also some small portions of the free polymer phase observed in the image, which is sometimes seen in high polymer-loaded composites (both PEO and PPO). As a downside of this method, a segregated Cl region was found, expected to be LiCl, indicating LiPSCl decomposition during the process. The decomposition could have originated from the dissolution of LiPSCl in ethanol where some of the crystals are completely dissolved and cannot reform back to the same structure. This effect can be minimized by the reduction of ethanol exposure time as mentioned earlier. For the mechanical properties of the LiPSCl-PPO composites, both the reduced Young's modulus and the hardness of the PPO composites are shown in FIGS. 4A and 4B. In the case of the composites from the solution-precipitation method, the composites with 2 wt % and 8 wt % of PPO show improved mechanical strength compared to the precipitated LiPSCl, but no significant improvement is observed when compared to the pristine LiPSCl. In addition, the mechanical reinforcement by PPO is negligible compared to the PEO system (FIGS. 3A and 3B). Similarly, the dispersion method did not show any noticeable improvement in mechanical strength when compared to the pristine LiPSCl, which is opposite to the LiPSCl-PEO composites. This result could be due to the incompatibility between the polar inorganic salt (LiPSCl) and a much less polar organic polymer (PPO), which might lower the interactions between solid electrolyte and the polymer, causing the degradation of mechanical properties.

Example—Effects of Polymer Species and their Content on the Li Conductivity

The effects of polymer species and their content on the Li conductivity were evaluated using electrochemical impedance spectroscopy (EIS). The conductivity decreases when the PEO content increases for both the dispersion and solution-precipitation methods. Note that the solution-precipitation method shows a more significant decrease in conductivity as the polymer content increases (10-2 mS/cm vs 1 mS/cm of pristine LiPSCl). The low conductivity could be attributed to the LiPSCl forming smaller crystals or an amorphous phase after the solution-precipitation reaction. Therefore, thermal treatment at a higher temperature is needed to improve the crystallinity of LiPSCl solid electrolytes. For the LiPSCl-PPO composites, the mechanical mix and the dispersion samples displayed similar conductivity and trends in which an increase in the polymer content lowers the conductivity of the materials. Interestingly, the conductivity of PPO composites from the solution-precipitation method exhibits a more negligible effect on the polymer content (from 2 wt % to 12 wt %). This could be due to the well-distributed polymer in which there is no large polymer domain to block ion-conductive channels. However, significantly lower conductivity of the solution-precipitated composite compared to the other two methods was observed in the case of 2 wt % and 8 wt % PPO content. It is likely that the uniform distribution of the polymer prevents the crystallization of LiPSCl and/or the exposure of LiPSCl to ethanol decomposes LiPSCl to other irreversible nonconductive salts, such as LiCl. Typically, LiPSCl is known to undergo hydrolysis with water, causing irreversible loss of sulfur by forming hydrogen sulfide (H₂S). In ethanol, it is expected that the LiPSCl may undergo ethanolysis, releasing H₂S but at a much slower rate than water since the available proton of ethanol to form H₂S is less active than that of water (pKₐ of 16 of ethanol vs pKₐ of 14 of water).

### Example—Stability of Dendrite Formation on the LiPSCl-PPO Composites

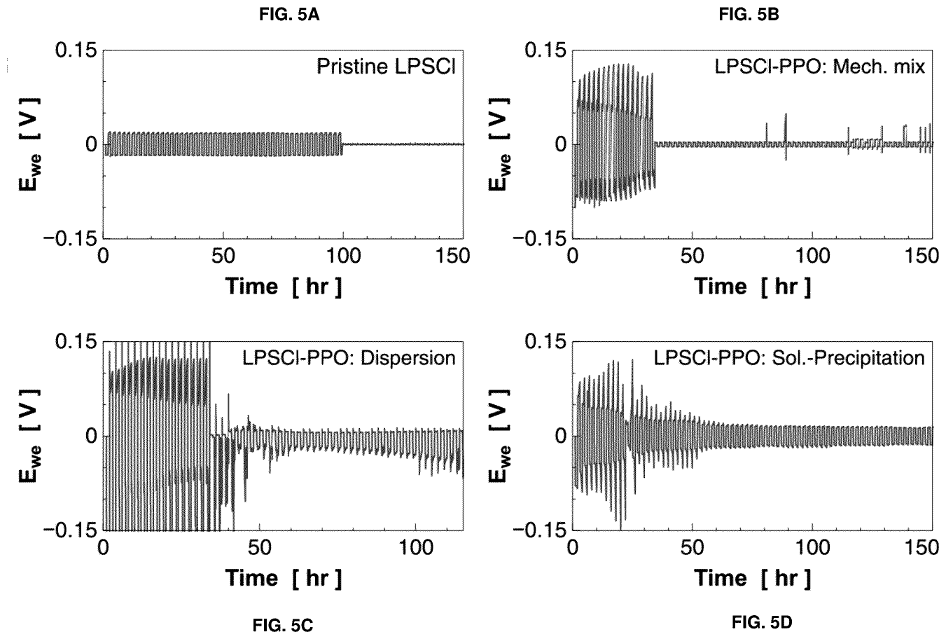

The stability of dendrite formation on the LiPSCl-PPO composites via repetitive Li striping/plating tests over time at a constant current with a rate of 0.1 mAh/cm² was investigated. Four materials were tested: three types of LiPSCl-PPO composite from solution-precipitation, dispersion mix, mechanical mix, and the pristine LiPSCl. The 12 wt % PPO-LiPSCl composite was selected from each method for the test because they exhibit comparable ionic conductivity to each other to avoid the effect of ionic conductivity on the Li striping/plating cycles. The cycle results are shown in FIGS. 5A-5D.

The pristine LiPSCl shows smooth Li striping-plating with a constant voltage for at most 50 cycles, followed by the voltage drop, indicating the penetration of dendrite across solid electrolyte. In contrast, the cycle of all three composites displays a high overpotential at the initial few cycles and tends to decrease after each cycle. These events could be contributed to the interface issues between Li metal and low ion-conductive PPO in the composite, which can increase interface resistance. During the cycle, the interface becomes reconstructed, resulting in a decrease in interface resistance. This explains the lowering of the overpotential during the cycle process. For both cells from mechanical mixing and dispersion composites, less than 20 cycles are observed before the voltage drop, implying lower stability toward dendrite formation than the pristine LiPSCl. Impressively, the cell made from the LiPSCl-PPO composite via the solution-precipitation displays incredibly high stability over 100 cycles without an observed voltage drop. Although the mechanical strength of the composite is lower than the pristine one, the stability toward dendrite formation can be improved, which is likely attributable to the lowering of electronic conductivity by uniformly distributing the electronic insulator, PPO, in solid electrolyte. These results further confirmed the importance of the homogeneous polymer phase distribution in the composite to sufficiently suppress the electronic conductivity.

### CONCLUSION

Further details regarding the embodiments described herein can be found in P. Khomein et al., “Lithium Phosphorus Sulfide Chloride-Polymer Composite via the Solution-Precipitation Process for Improving Stability toward Dendrite Formation of Li-Ion Solid Electrolyte,” ACS Appl. Mater. Interfaces 2023, 15, 11723-11730, which is hereby incorporated by reference.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

What is claimed is:

1. A method comprising:
providing a lithium phosphorus sulfur halide (LiPSX) solution and providing a polymer solution, with X being chlorine, bromine, iodine, or combinations thereof;
precipitating LiPSX of the LiPSX solution and a polymer of the polymer solution by mixing the LiPSX solution and the polymer solution; and
removing a LiPSX solvent of the LiPSX solution and a polymer solvent of the polymer solution from the LiPSX and the polymer to form polymer-embedded LiPSX.

2. The method of claim 1, wherein the polymer-embedded LiPSX is in the form of clusters.

3. The method of claim 1, wherein the LiPSX is LiPSCl.

4. The method of claim 1, wherein the LiPSX solvent comprises a polar solvent.

5. The method of claim 1, wherein the LiPSCl solvent comprises ethanol.

6. The method of claim 1, wherein the polymer comprises polyethylene oxide and the polymer solvent comprise acetonitrile.

7. The method of claim 1, wherein the polymer comprises poly(phenylene oxide) and the polymer solvent is a solvent from a group toluene, benzene, xylene, dioxolane, and glyme.

8. The method of claim 1, further comprising:
annealing the polymer-embedded LiPSX at about 400° C. or greater to further crystallize the LiPSX.

9. The method of claim 1, further comprising:
grinding the polymer-embedded LiPSX to form a powder.

10. The method of claim 9, wherein particle sizes of the polymer-embedded LiPSX powder are about 0.1 microns to 50 microns.

11. The method of claim 1, further comprising:
compressing the powder to form an electrolyte.

12. The method of claim 11, wherein the electrolyte is about 2 weight % polymer or greater.

13. A method comprising:
providing a lithium phosphorus sulfur chloride (LiPSCl) solution and providing a solution of polyethylene oxide;
precipitating LiPSCl and polyethylene oxide by mixing the LiPSCl solution and the solution of polyethylene oxide; and
removing ethanol of the LiPSCl solution and acetonitrile of the solution of polyethylene oxide from the LiPSCl and the polyethylene oxide to form polyethylene oxide-embedded LiPSCl.

14. The method of claim 13, further comprising:
annealing the polyethylene oxide-embedded LiPSCl at about 150° C. to 210° C., or about 180° C., to further crystallize the LiPSCl.

15. The method of claim 13, further comprising:
grinding the polymer-embedded LiPSX to form a powder.

16. The method of claim 13 wherein particle sizes of the polymer-embedded LiPSX powder are about 0.1 microns to 50 microns.

17. A method comprising:
providing a lithium phosphorus sulfur chloride (LiPSCl) solution and providing a solution of poly(phenylene oxide);
precipitating LiPSCl and poly(phenylene oxide) by mixing the LiPSCl solution and the solution of poly(phenylene oxide); and
removing ethanol of the LiPSCl solution and a polymer solvent of the solution of poly(phenylene oxide) from the LiPSCl and the poly(phenylene oxide) to form poly(phenylene oxide)-embedded LiPSCl, the polymer solvent being a solvent from a group toluene, benzene, xylene, dioxolane, and glyme.

18. The method of claim 17, further comprising:
annealing the poly(phenylene oxide)-embedded LiPSCl at about 400° C. or greater to further crystallize the LiPSX.

19. The method of claim 17, further comprising:
grinding the polymer-embedded LiPSX to form a powder.

20. The method of claim 17, wherein particle sizes of the polymer-embedded LiPSX powder are about 0.1 microns to 50 microns.
